(19) United States
(12) Patent Application Publication
(10) Pub. No.: US 2010/0242741 A1
(43) Pub. Date: Sep. 30, 2010

(54) Flexible food skewer systems

(76) Inventors: Todd R. Gentry, Winfield, KS (US); James H. Jones, Wichita, KS (US)

Correspondence Address: GREENBERG TRAURIG, LLP, 77 WEST WACKER DRIVE, SUITE 3100, CHICAGO, IL, 60601-1732, US

(21) Appl. No.: 12/800,241

(22) Filed: May 11, 2010

Related U.S. Application Data
(63) Continuation-in-part of application No. 10/798,155, filed on Mar. 9, 2004.

(51) Int. Cl. A47J 37/04

(52) U.S. Cl. 99/419

(57) ABSTRACT

A flexible food skewer system for providing versatile cooking upon a grill. The flexible food skewer system includes an elongated flexible member, a loop extending from an end and formed in part from the flexible member, and a piercing element extending from an opposite end of the flexible member are provided. In use, the user is able to manipulate the shape of the flexible member about other food items on the grill while allowing the loop and piercing implement to be exterior of the grill if desired. A second piercing implement may be provided instead of the loop. In further alternative embodiments of the invention, two or more flexible skewer systems may be intertwined to provide greater and reinforced food carrying capacity. Various alternative structures are provided to enable secured, releasable interlocking of the intertwined skewer systems.

This application is a continuation-in-part of, and claims priority of the filing date of, U.S. Ser. No. 10/798,155, filed Mar. 9, 2004 and presently pending.

### CROSS REFERENCE TO RELATED APPLICATIONS

Not applicable to this application.

### STATEMENT REGARDING FEDERALLY SPONSORED RESEARCH OR DEVELOPMENT

Not applicable to this application.

### BACKGROUND OF THE INVENTION

1. The Technical Field

The present invention relates generally to cooking utensils, and more specifically it relates to a flexible food skewer system for providing versatile cooking upon a grill, among other food cooking environments.

2. Description of the Related Art

Skewers have been in use for years for cooking food (e.g. steak, chicken, vegetables) upon a grill or other cooking environment. A conventional skewer is comprised of a rigid, straight rod structure having an end member and a pointed end. A conventional skewer is typically constructed of a rigid metal rod or wood rod.

The user of a conventional skewer first inserts the food items upon the shaft of the conventional skewer and then positions the skewer upon the grill. Since a conventional skewer is a rigid straight structure, the user typically positions the entire skewer upon the grill. If the user attempts to extend the end member of the skewer outside of the grill cover, the grill cover will sometimes not completely close. In addition, since the conventional skewer is a rigid and straight structure, it can be difficult to efficiently utilize the grill surface area when other food items such as chicken legs, steaks, sausage and the like are on the grill. A further problem with conventional skewers is that they can be difficult to utilize within food items with bones such as chicken legs and wings since they can only pass through the meat portion in a straight line.

While these devices may be suitable for the particular purpose to which they address, they are not as suitable for providing versatile cooking upon a grill. Conventional skewers are not suitable for versatile cooking of food items.

In these respects, the flexible skewer system according to the present invention substantially departs from the conventional concepts and designs of the prior art, and in so doing provides an apparatus primarily developed for the purpose of providing versatile cooking upon a grill.

### SUMMARY OF THE INVENTION

In view of the foregoing disadvantages inherent in the known types of skewers now present in the prior art, the present invention provides a new flexible skewer system construction wherein the same can be utilized for providing versatile cooking upon a grill.

The general purpose of the present invention, which will be described subsequently in greater detail, is to provide a new flexible skewer system that has many of the advantages of the skewers mentioned heretofore and many novel features that result in a new flexible skewer system which is not anticipated, rendered obvious, suggested, or even implied by any of the prior art skewers, either alone or in any combination thereof.

To attain this, the present invention generally comprises an elongated flexible member, a loop extending from an end of the flexible member and a piercing implement extending from an opposite end of the flexible member. The flexible member is preferably comprised of a stainless steel cable. In use, the user is able to manipulate the shape of the flexible member about other food items on the grill while allowing the loop and piercing implement to be exterior of the grill. Alternatively, a second piercing implement may be utilized instead of a loop.

In another embodiment of the invention, the invention comprises a cooking utensil, for retaining, by sequential impalement thereon, one or more food items to be cooked. An elongated flexible high-temperature resistant member, having first and second ends, is provided. A piercing member is affixed to the first end of the elongated flexible high-temperature resistant member. The second end of the elongated flexible high-temperature resistant member has a gripping loop formed thereon, and a retaining member disposed longitudinally between the gripping loop and a remaining portion of the flexible member.

Another embodiment of the invention comprises a cooking utensil, for retaining, by sequential impalement thereon, one or more food items to be cooked, wherein an elongated flexible high-temperature resistant member is provided, having first and second ends. A piercing member is affixed to the first end of the elongated flexible high-temperature resistant member. The second end of the elongated flexible high-temperature resistant member has a gripping loop formed thereon, and a retaining member may be disposed longitudinally between the gripping loop and a remaining portion of the flexible member.

There has thus been outlined, rather broadly, the more important features of the invention in order that the detailed description thereof may be better understood, and in order that the present contribution to the art may be better appreciated. There are additional features of the invention that will be described hereinafter and that will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

To the accomplishment of the above and related objects, this invention may be embodied in the form illustrated in the accompanying drawings, attention being called to the fact, however, that the drawings are illustrative only, and that changes may be made in the specific construction illustrated and described within the scope of the appended claims.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 is a top view of the present invention.

FIG. 2 is a top View of the present invention wherein two units are interconnected to one another.

FIG. 3 is a top View of an alternative embodiment utilizing two piercing implements.

FIG. 4 is a top view of the present invention with food attached upon the flexible member.

FIG. 5 is a top view of the flexible member with food attached and positioned upon grill.

FIG. 6 is a top view of the flexible member with food attached and positioned upon grill with the piercing implement and the loop extending out the front portion of the grill.

FIG. 7 is an upper perspective view of the distal ends of the present invention extending from a grill. bag.

FIG. 8 is a front view of the present invention positioned within a marinade

FIG. 9 is front view of the present invention positioned within a deep fryer.

FIG. 10 is a plan view of an alternative cooking utensil, of an alternative embodiment of the present invention, showing an alternative sleeve arrangement for the gripping loop formed on an end opposite the piercing member.

FIG. 11 is a perspective view of the alternative cooking utensil according to the embodiment of FIG. 10, showing how it may be looped upon itself, to hold items skewered thereon.

FIG. 12 is a plan view of an alternative composite cooking utensil according to an alternative embodiment, wherein two cooking utensils according to the embodiment of FIG. 10 are shown interconnected to one another.

FIG. 13 is a plan view of an alternative cooking utensil, of an alternative embodiment of the invention, showing a gripping medallion, positioned proximate the gripping loop.

FIG. 14 shows the cooking utensil of FIG. 13 looped upon itself, so as to capture food items skewered thereon.

FIG. 15 is a further view of the cooking utensil of FIGS. 13-14, showing in particular the structure for crimping/capturing the cable in the gripping medallion.

FIG. 16 is a plan view of an alternative composite cooking utensil according to an alternative embodiment, wherein two cooking utensils according to the embodiment of FIGS. 13-15 are shown interconnected to one another.

### DETAILED DESCRIPTION OF THE INVENTION

While this invention is susceptible of embodiment in many different forms, there are shown in the drawings and will herein be described in detail, several embodiments with the understanding that the present disclosure should be considered as an exemplification of the principles of the invention and is not intended to limit the invention to the embodiments so illustrated. Further, to the extent that any numerical values or other specifics of materials, etc., are provided herein, they are to be construed as exemplifications of the inventions herein, and the inventions are not to be considered as limited thereby.

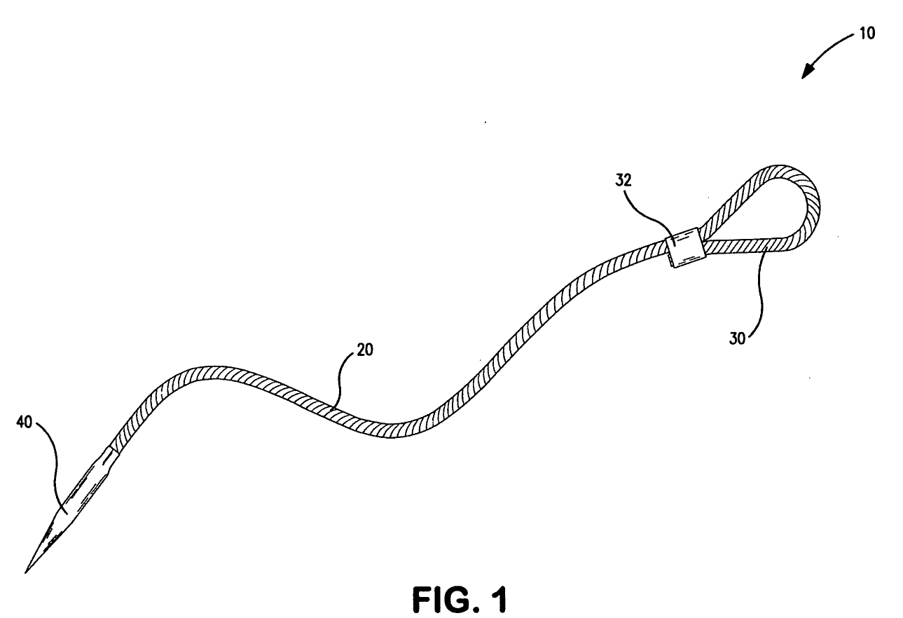

Turning now descriptively to the drawings, in which similar reference characters denote similar elements throughout the several views, FIGS. 1 through 9 illustrate a flexible skewer system 10, which comprises an elongated flexible member 20, a loop extending from an end of the flexible member 20 and a piercing implement 40 extending from an opposite end of the flexible member 20. The flexible member 20 is preferably comprised of a stainless steel cable. In use, the user is able to manipulate the shape of the flexible member 20 about other food items on the grill 12 while allowing the loop and piercing implement 40 to be exterior of the grill 12. Alternatively, a second piercing implement 40 may be utilized instead of a loop.

The elongated flexible member 20 has a first end and a second end as shown in Fig. I of the drawings. The flexible member 20 is preferably comprised of a flexible structure as illustrated in the drawings. The flexible member 20 is preferably comprised of a flexible metal cable (e.g. stainless steel cable).

The flexible member 20 preferably has a length greater than approximately twenty inches to accommodate a number of food items and for providing a sufficient length to allow the ends to both extend outside of the grill 12. The flexible member 20 preferably has a diameter of approximately 3/32 inches.

An end member 30 preferably extends from the first end of the flexible member 20 opposite of the piercing implement 40 as shown in FIG. 1 of the drawings. The end member 30 may be comprised of various structures including but not limited to a loop, eyelet, tee-member, ferrule and the like. However, it is preferable that the end member 30 is comprised of a loop or eyelet so that two units of the present invention may be attached to one another. As shown in FIG. 1 of the drawings, a sleeve 32 is preferably secured to the flexible member 20 to secure the first end to the flexible member 20 thereby forming the loop.

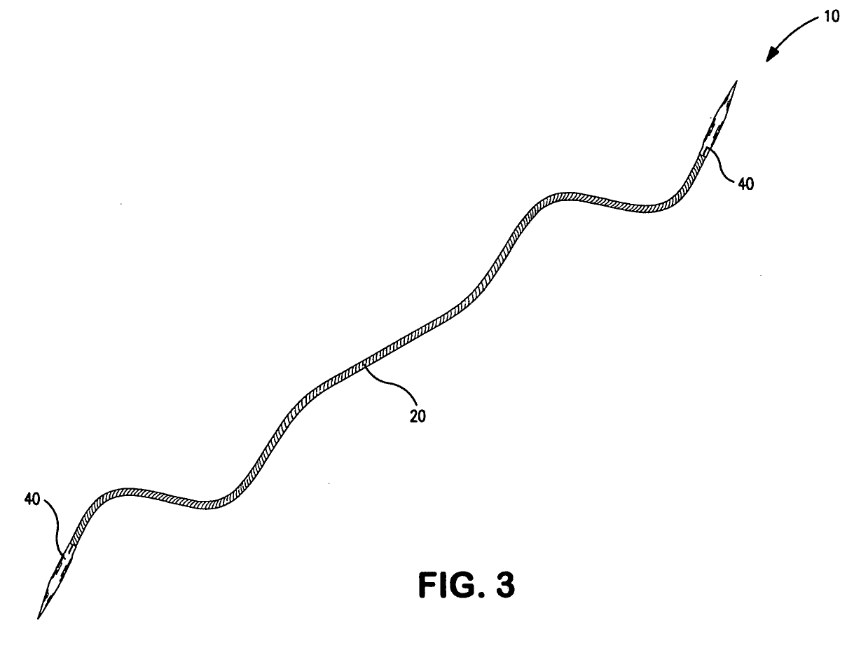

The piercing implement 40 extends from the second end of the flexible member 20 opposite of the end member 30 as shown in FIG. 1 of the drawings. The piercing implement 40 preferably has a pointed end for providing easy insertion into food items such as meat and vegetables. As shown in FIG. 3 of the drawings, a second piercing implement 40 may be attached to the first end of the flexible member 20 instead of the end member 30.

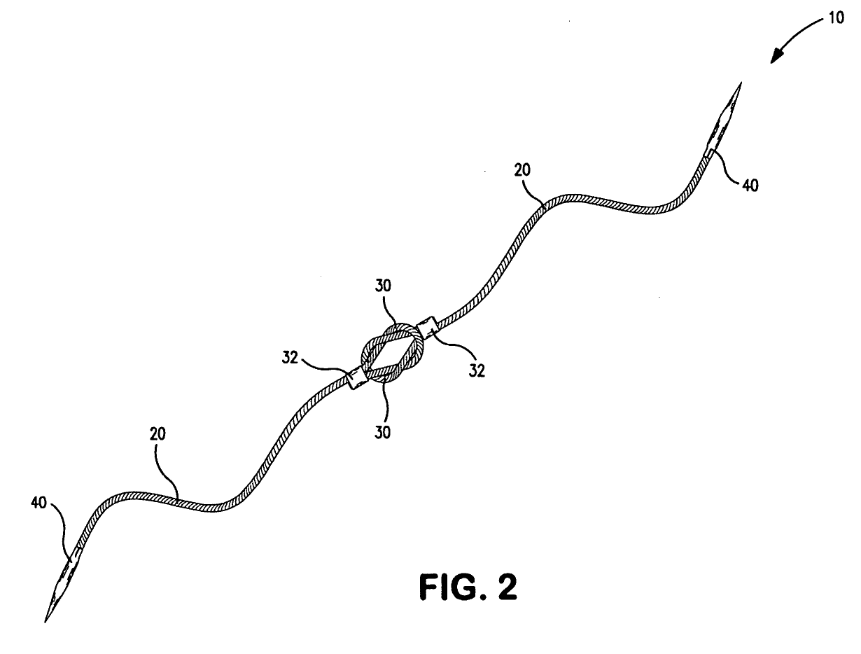

The user first determines the desired length they will require for the flexible skewer 10 based upon the amount and size of food items. FIG. 2 illustrates attaching two flexible skewers 10 together by inserting the flexible skewers 10 through the loop of the opposing flexible skewer 10.

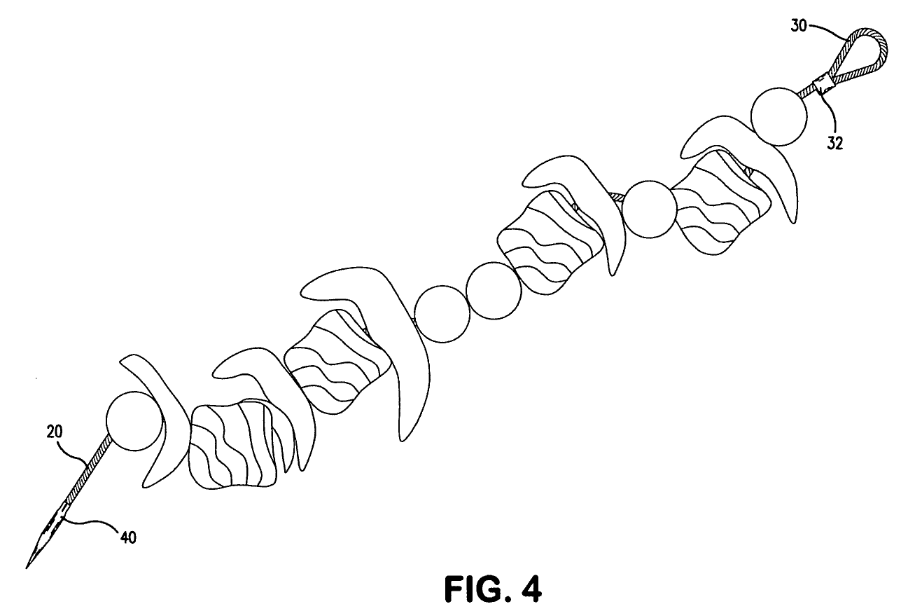

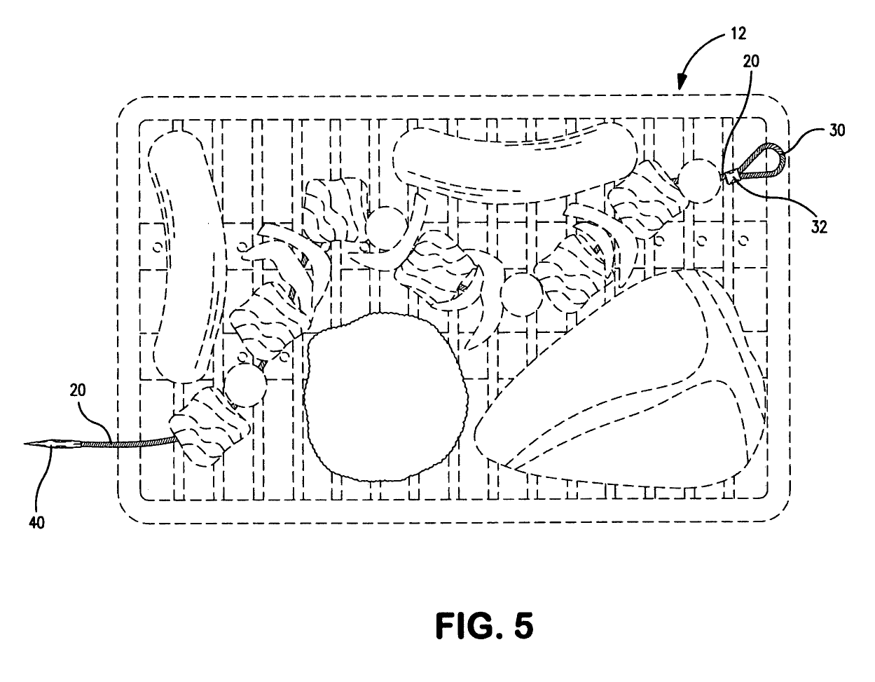

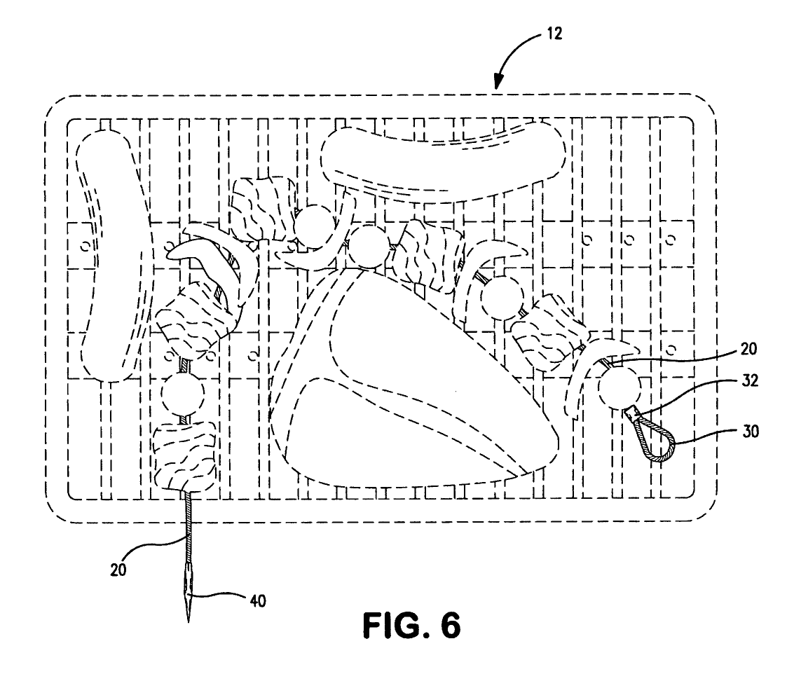

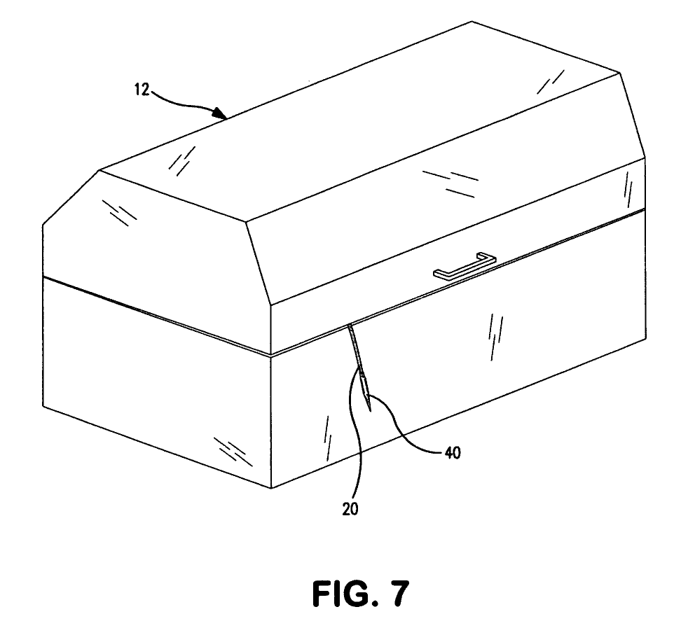

The user then attaches one or more food items upon the flexible member 20 by inserting the piercing implement 40 through thereof as shown in FIG. 4 of the drawings. The user then positions the flexible skewer 10 upon a cooking surface such as a grill 12 as shown in FIGS. 5 and 6 of the drawings. The user then typically manipulates the flexible skewer 10 about other food items on the cooking surface that are not attached to the flexible skewer 10 as further shown in FIGS. 5 and 6 of the drawings. The user also positions at least one end of the first flexible member 20 external of the cooking surface as shown in FIGS. 5 through 7 of the drawings. The user may then close the cover of the grill 12 with the flexible member 20 bending underneath the cover to allow for full closing of the cover as shown in FIG. 7 of the drawings.

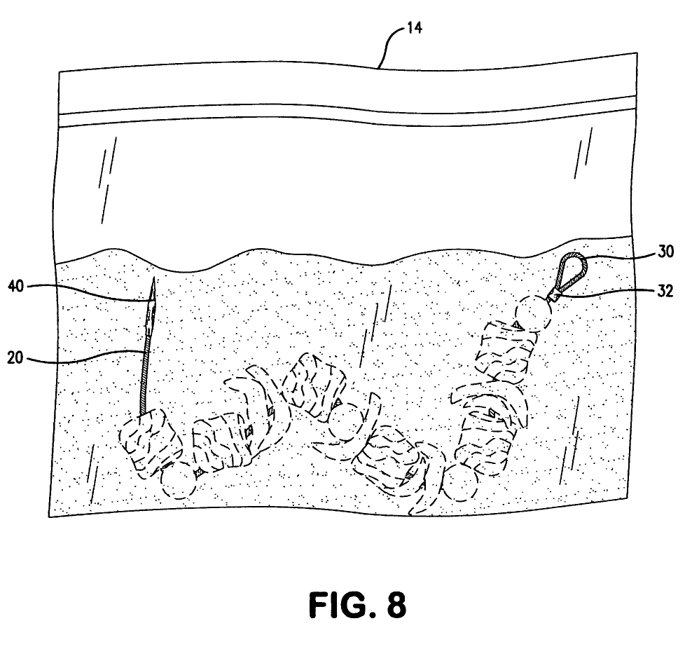

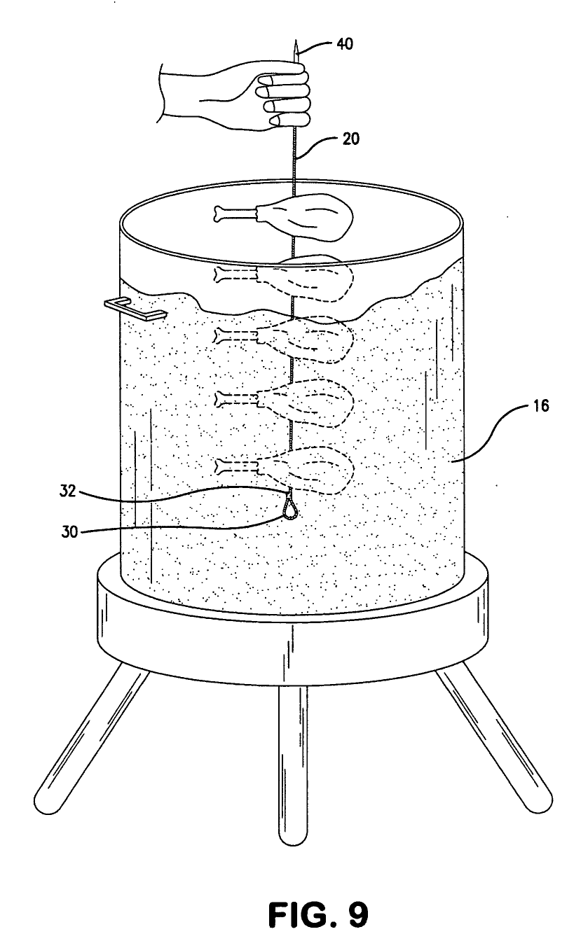

FIGS. 8 and 9 illustrate additional alternative uses of the present invention. FIG. 8 illustrates marinating various food items within a marinade bag 14 before cooking the food items. FIG. 9 illustrates positioning the present invention within a deep fryer 16 for cooking various food items. The present invention may also be utilized in various other commonly utilized cooking environments.

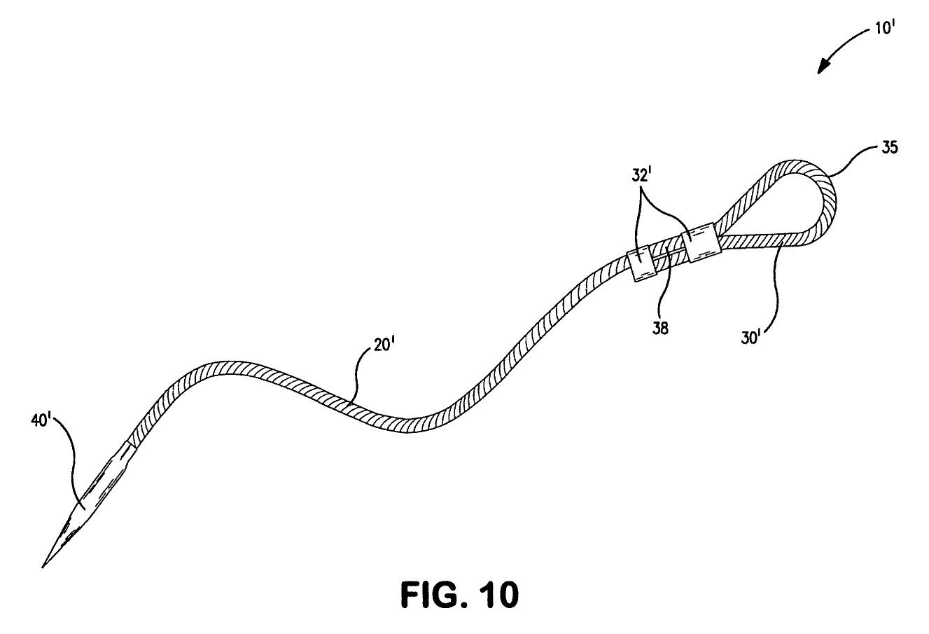

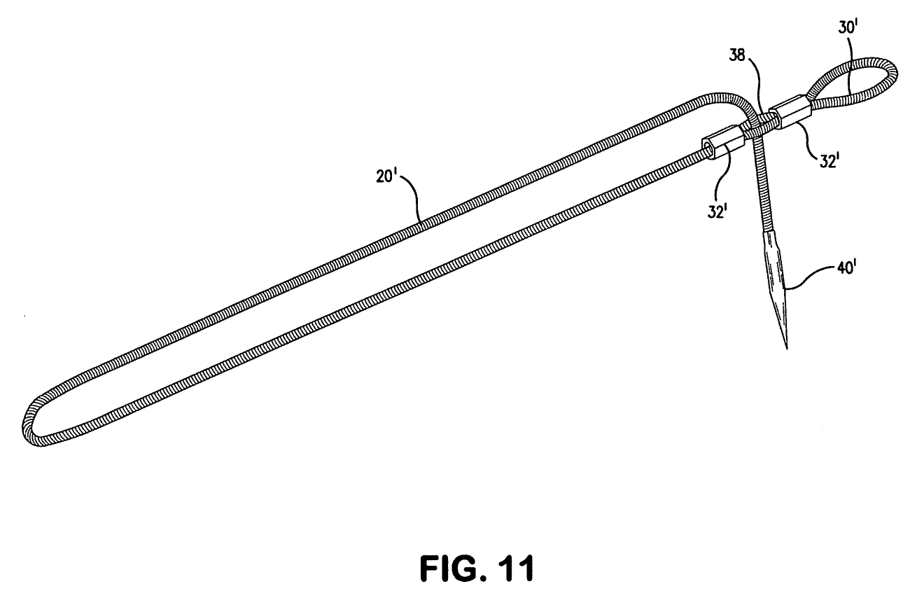

FIGS. 10 and 11 illustrate a cooking utensil according to an alternative embodiment of the invention. Structural elements which are similar or analogous in function to corresponding structural elements shown and described with respect to the embodiments of FIGS. 1-9 are provided with like reference numerals, augmented by a prime (′).

Flexible skewer system 10′ is formed from flexible member (cable) 20′, having end member 30′ formed at one end, and having piercing-element 40′ affixed to the opposite second end of end member 30′. To secure the end of flexible member 20′ to form end member 30′, two sleeves 32′ are provided, one connecting the extreme tip of flexible member 20′ to a portion of flexible member 20′ distal to the extreme tip, and a second sleeve 32′ positioned between the first sleeve 32′ and bight 35 of the loop. The first and second sleeves 32′ create a gap between juxtaposed adjacent portions of the flexible member 20′ to form a second, smaller loop 38. In preferred versions of this embodiment, all of the components making up each flexible skewer system 10′ is fabricated from high-temperature (and/or flame) resistant and food-safe materials, such as stainless steel for flexible member 20′. Sleeves 32′ and piercing elements 40′ likewise may be fabricated from stainless steel or similar high-temperature (and/or flame) resistant and food-safe materials. In embodiments that are fabricated from stainless steel (both the flexible member 20′ and piercing element 40′), when piercing element 40′ is left off of the grill, so as to extend even a relatively short distance, because stainless steel has relatively low thermal conductivity, it may be possible to grasp flexible skewer system 10′ by piercing element 40′ barehanded (without gloves), even after a substantial period of time over the grill. Accordingly, alternative embodiments of the invention may be fabricated from other high-temperature resistant, low conductivity materials, that have conductivities lower than, e.g., non-stainless steel cable, copper, etc. Grasping by the piercing element 40 is done because to raise flexible skewer system 10′ solely by the loop may result in the food articles (raw or cooked) sliding off of the flexible skewer system 10′.

According to one method of use, shown in FIG. 11, a single skewer system 10′ may be looped upon itself, after food items (not shown) have been skewered thereon, and the piercing element 40′ has been passed through smaller loop 38. The resulting structure is capable of being carried, or even suspended, via bight 35 of the end loop 30′.

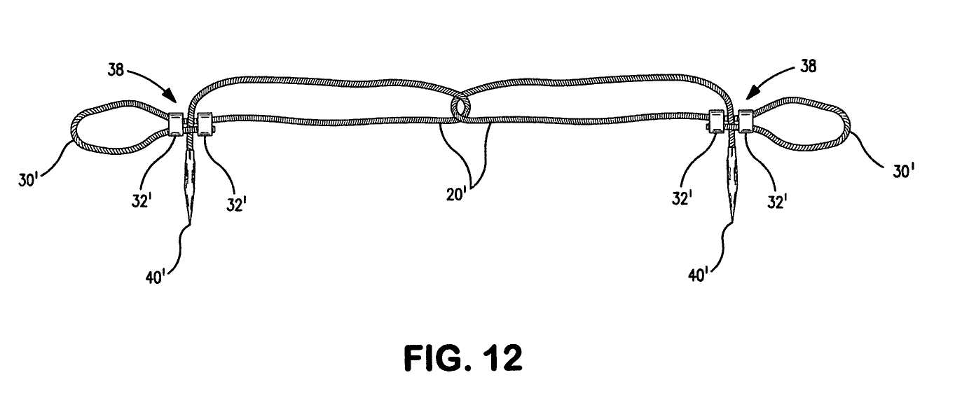

In an alternative method of use, loop 38 permits two flexible skewer systems 10′ to be intertwined, as shown in FIG. 12. In use, food items (not shown) may be impaled upon each skewer system 10′, along the portion of each flexible member 20′, between a point approximately half-way between sleeves 32′ and piercing element 40′, and then the flexible members 20′ will be crossed at 34′. Then, if desired, additional food items (not shown) may then be impaled upon each skewer system 10′, between crossing 34′ and the respective piercing elements 40′. Then, the piercing element 40′ of each system 10′ is passed through loop 38 of the other system 10′, leaving end members 30′ free to be used as gripping loops, to facilitate handling of the intertwined flexible skewer systems 10′.

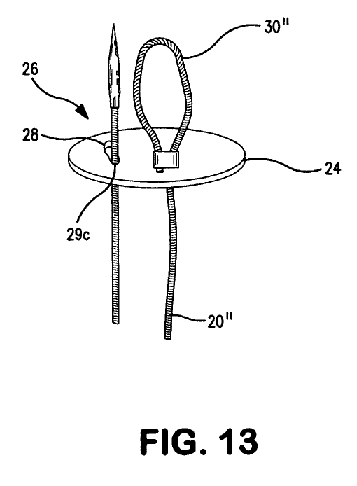

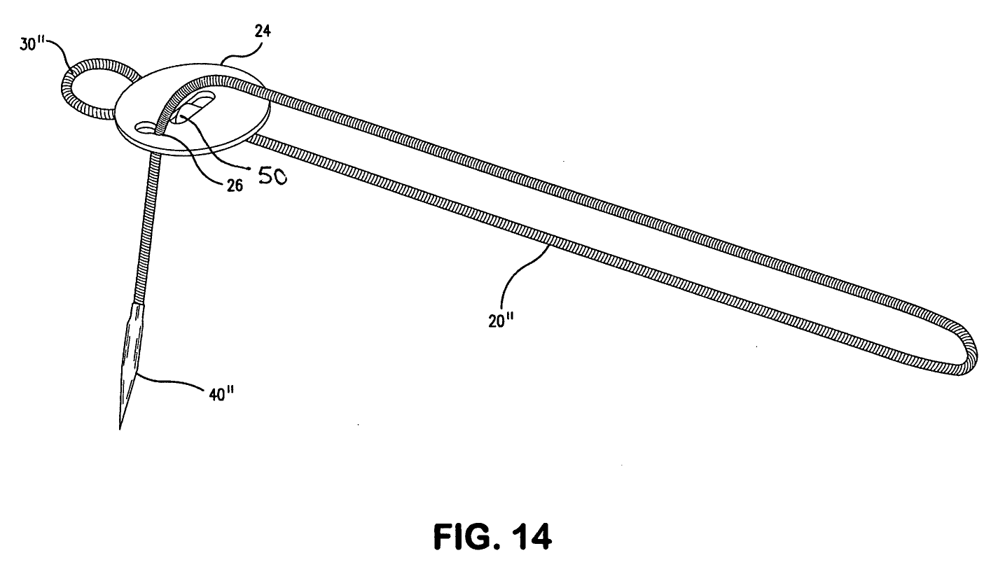

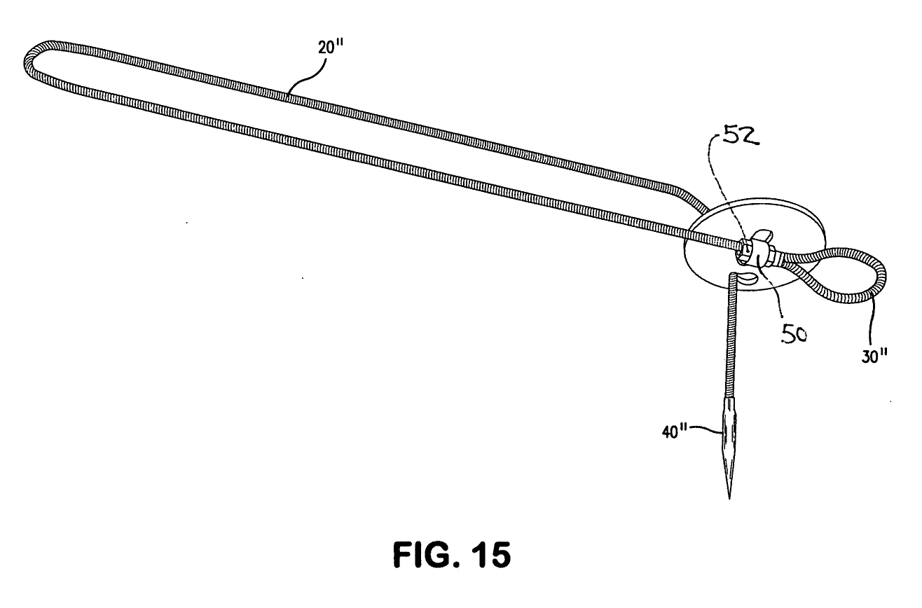

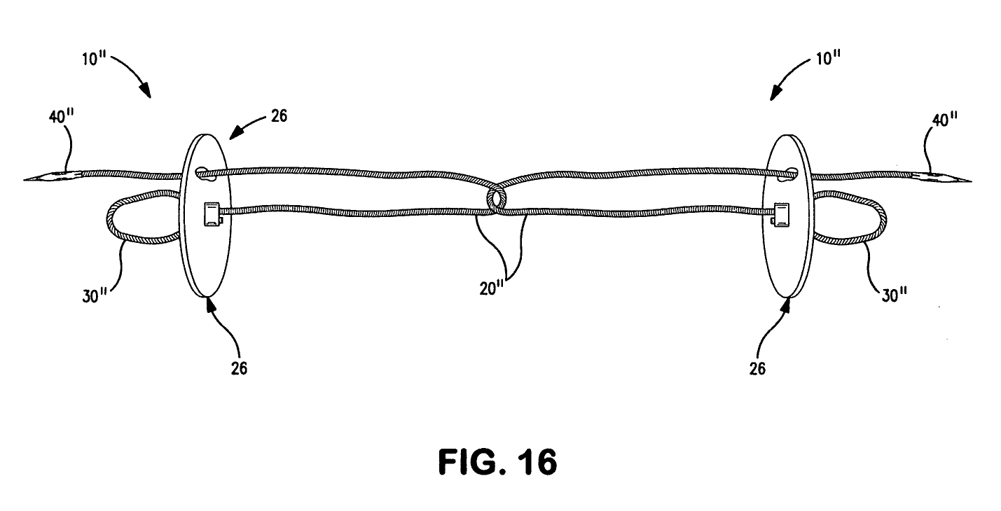

FIGS. 13-16 illustrate another alternative embodiment of the invention, wherein structural elements which are similar or analogous in function to corresponding structural elements shown and described with respect to the embodiments of FIGS. 1-11 are provided with like reference numerals, augmented by a double prime (″). The embodiment of FIGS. 13-16 is similar to the embodiment of FIGS. 10-12, with the additional provision of a locking mechanism, to help hold the flexible skewer systems 10″ in their looped configurations. In this embodiment, instead of using pairs of spaced apart sleeves 32″ on each flexible member, a flat planar medallion or disk 24 (preferably fabricated from flame or high-temperature resistant and food safe metal material) is provided, through which a flexible member 20″ is passed. Each medallion or disk 24 may be affixed to its respective flexible member 20″ by crimping a portion 50 of the material forming medallion or disk 24 to flexible member 20″ either directly or through the use of an intermediate collar 52 used to help form loop 30″ (see, e.g., FIGS. 14-15; no particular attachment method is intended to be illustrated by FIG. 13 or 16). As an alternative, an intermediate member, similar to sleeves 32′, may be affixed (e.g., by welding, brazing, etc.) to the medallion or disk 24 and then crimped (or welded or brazed, etc.) to flexible member 20″.

A teardrop or keyhole shaped opening 26 is formed in each medallion or disk 24, which has a wider-diameter portion 28, which is large enough to permit the passage of a piercing element 40″, and a narrower-width portion 29, which is narrower than the diameter of flexible member 20″.

FIGS. 14 and 15 show how a single skewer system 10″ may be looped upon itself, and the piercing element end 40″ passed through opening 26, and then flexible member 20″ is pushed sideways into the narrower portion 29, and gripped thereby. As with the embodiment of FIGS. 10-12, loop 30″ permits skewer system 10″ to be carried or suspended (during cooking), as well as facilitating cooking on a grill.

In use, food items (not shown) will be placed on each of skewer systems 10″, in a manner similar to that described with respect to the embodiment of FIGS. 10-12. Piercing elements 40″ of the respective skewer systems 10″ will be passed through the openings 26 of the medallions or disks 24 of the corresponding other skewer systems 10″, and then the respective flexible members 20″ will be pulled into the narrower-width portions 29 of the disks 24, into binding frictional engagement therewithin, to prevent the intertwined skewer systems 10″ from becoming undone, during handling.

What has been described and illustrated herein is a preferred embodiment of the invention along with some of its variations. The terms, descriptions and figures used herein are set forth by way of illustration only and are not meant as limitations. Those skilled in the art will recognize that many variations are possible within the spirit and scope of the invention, which is intended to be defined by the following claims (and their equivalents) in which all terms are meant in their broadest reasonable sense unless otherwise indicated. Any headings utilized within the description are for convenience only and have no legal or limiting effect.

The foregoing description and drawings merely explain and illustrate the invention, and the claims are not so limited as those skilled in the art who have the disclosure before them will be able to make modifications and variations therein without departing from the scope of the invention.

1. A cooking utensil, for retaining, by sequential impalement thereon, one or more food items to be cooked, comprising:
an elongated flexible high-temperature resistant member, having first and second ends;
a piercing member affixed to the first end of the elongated flexible high temperature resistant member;
the second end of the elongated flexible high-temperature resistant member having a gripping loop formed thereon, and a retaining member disposed longitudinally between the gripping loop and a remaining portion of the flexible member.

2. The cooking utensil according to claim 1, wherein the retaining member comprises a secondary loop disposed longitudinally between the gripping loop and a remaining portion of the flexible member.

3. The cooking utensil according to claim 1, wherein the elongated flexible high-temperature resistant member is a metal cable.

4. The cooking utensil according to claim 3, wherein the metal cable is fabricated from stainless steel.

5. The cooking utensil according to claim 1, wherein the gripping loop formed on the second end of the elongated flexible high-temperature resistant member further comprises a first sleeve affixed simultaneously to a portion of the second end of the elongated flexible high-temperature resistant member that has been folded back upon itself, and to an unfolded portion of the elongated flexible high-temperature resistant member disposed immediately adjacent thereto.

6. The cooking utensil according to claim 5, wherein the secondary loop formed on the elongated flexible high-temperature resistant member further comprises a second sleeve affixed simultaneously to the portion of the second end of the elongated flexible high-temperature resistant member that has been folded back upon itself, between the first sleeve and an extreme tip of the second end, and to the folded portion of the elongated flexible high-temperature resistant member between the first sleeve and the first end of the elongated flexible high-temperature resistant member.

7. A cooking utensil system according to claim 2, wherein the elongated flexible high-temperature resistant member, after having one or more food items impaled thereon, is folded upon itself, and the piercing element is passed through the secondary loop and retained there, facilitating carrying of the cooking utensil system and/or suspension of the cooking utensil system during cooking.

8. A cooking utensil system incorporating at least two of the cooking utensils of claim 2, wherein the elongated flexible high-temperature resistant member of a first one of the at least two cooking utensils is intertwined with the elongated flexible high-temperature resistant member of at least a second one of the at least two cooking utensils, and then the first ends of the elongated flexible high-temperature resistant members of the at least first and second cooking utensils are folded back and inserted into the secondary loops of the respective at least first and second cooking utensils.

9. The cooking utensil according to claim 1, wherein the retaining member comprises a planar member affixed to the elongated flexible high-temperature resistant member between the gripping loop and the first end of elongated flexible high-temperature resistant member.

10. The cooking utensil according to claim 9 wherein the planar member includes an opening operably configured to grippingly receive a first end of an elongated flexible high-temperature resistant member.

11. A cooking utensil system according to claim 10, wherein the elongated flexible high-temperature resistant member, after having at least one food item impaled thereon, is looped upon itself, inserted into the opening in the planar member of the cooking utensils, and grippingly wedged therein.

12. A cooking utensil system incorporating at least two of the cooking utensils of claim 9, wherein the elongated flexible high-temperature resistant member of a first one of the at least two cooking utensils is intertwined with the elongated flexible high-temperature resistant member of at least a second one of the at least two cooking utensils, and then the first ends of the elongated flexible high-temperature resistant members of the at least first and second cooking utensils are folded back and inserted into the openings in the planar members of the respective at least first and second cooking utensils, and grippingly wedged therein.
